(19) United States
(12) Patent Application Publication
(10) Pub. No.: US 2022/0225231 A1
(43) Pub. Date: Jul. 14, 2022

(54) POWER SAVING IN MESH NETWORK

(71) Applicant: Hewlett Packard Enterprise Development LP, Houston, TX (US)

(72) Inventors: Junyu PEI, Beijing (CN); Xuguang JIA, Beijing (CN); Xiaoyang FU, Beijing (CN)

(21) Appl. No.: 17/146,086

(22) Filed: Jan. 11, 2021

(51) Int. Cl. H04W 52/02; H04W 74/00; H04W 84/18; H04W 28/02; H04W 80/02; H04W 76/14

(52) U.S. Cl. CPC H04W 52/0216; H04W 74/004; H04W 76/14; H04W 28/021; H04W 80/02; H04W 84/18

(57) ABSTRACT

In embodiments of the present disclosure, there is provided an approach for power saving in a mesh network. According to embodiments of the present disclosure, a mesh portal transmits, to a mesh point in a sleep mode, a packet for waking up the mesh point during a predetermined time period. The mesh point in the sleep mode detects the packet during the predetermined time period. In accordance with a determination that the mesh point is waked up, the mesh portal establishes a mesh link with the mesh point. Embodiments of the present disclosure provide an effective way for power saving in a mesh network.

### BACKGROUND

A mesh network is a communication network comprising radio nodes such as APs in mesh topology. An AP joining a mesh network usually acts as a mesh portal point (MPP, also referred to as “mesh portal”) or a mesh point (MP). An MPP is a gateway which connects the mesh network and an external network, such as, Wide Area Network (WAN). In the mesh network, the MPP communicates with MPs and enables these MPs to communicate with the external network. An MP is a node which supports wireless communication and mesh functions, such as, automatic topology discovery, automatic route discovery, and data packet forwarding. It is easy to extend a mesh network based on wireless uplinks. Due to its large coverage, the mesh network usually requires more power than a conventional network. Therefore, it would be desirable to implement power saving in a mesh network.

### BRIEF DESCRIPTION OF THE DRAWINGS

Embodiments of the present disclosure may be understood from the following Detailed Description when read with the accompanying Figures. In accordance with the standard practice in the industry, various features are not drawn to scale. In fact, the dimensions of the various features may be arbitrarily increased or reduced for clarity of discussion. Some examples of the present disclosure are described with respect to the following figures:

FIG. 1 illustrates an example environment in which embodiments of the present disclosure can be implemented;

FIG. 2 illustrates a schematic diagram of conversion among different modes of an AP according to embodiments of the present disclosure;

FIG. 3 illustrates a schematic diagram of the TWT sleep mode according to embodiments of the present disclosure:

FIG. 4 illustrates a signaling chart of an example process for entering and waking up from the probe sleep mode according to embodiments of the present disclosure;

FIG. 5 illustrates an example AP according to embodiments of the present disclosure:

FIG. 6 illustrates a flow chart of an example method for power saving according to embodiments of the present disclosure:

FIG. 7 illustrates an example AP according to embodiments of the present disclosure; and

FIG. 8 illustrates a flow chart of an example method for power saving according to embodiments of the present disclosure.

### DETAILED DESCRIPTION

Traditionally, there are several mechanisms enabling a wired or wireless device to fall asleep and wake up for the purpose of power saving. For example, a technology called Wakeup over Local Area Network (“WoLAN”) enables a wired AP to fall asleep and wake up for the purpose of power saving. However, WoLAN is only suitable for a wired AP but not suitable for the mesh network scenario. A technology called Wakeup over Wireless Local Area Network (“WoWLAN”) enables a wireless device with rich features (for example, a laptop) to fall asleep and wake up for the purpose of power saving. However, WoWLAN is not suitable for an AP. According to WoWLAN, if a wireless device falls asleep, the whole system of the wireless device except a Wi-Fi module would fall asleep and the Wi-Fi module would always keep connected with an AP. As such, WoWLAN is not efficient enough for an AP, since the RF module is the major power consumption module in the AP.

Usually, there are four components with power requirements in an AP, including Central Processing Unit (CPU), RF module, Ethernet module and Universal Serial Bus (USB) module. In the mesh network scenario, some of the components can be shut down for the purpose of power saving. For example, the Ethernet and USB modules could be shut down since they don't work as wireless uplink for a MP. For example, the frequency of CPU can be reduced or WoWLAN can be applied to CPU, so as to reduce the power consumption of CPU. The radio module would be a bottleneck in reducing the power consumption of the AP. The radio module usually works with the maximum transmit power in consideration of the signal quality and coverage.

Embodiments of the present disclosure propose a solution for power saving, so as to solve the above problems and one or more of other potential problems. This solution enables one or more APs (for example, a MPP and/or a MP) in a mesh network to fall asleep and wake up. According to this solution, if only a MP falls asleep and a MPP keeps awake, the MP can be waked up by a MPP. If both a MPP and a MP fall asleep, the MPP can be waked up based on WoLAN and then the MP can be waked up by the MPP. In this way, power saving in a mesh network can be implemented.

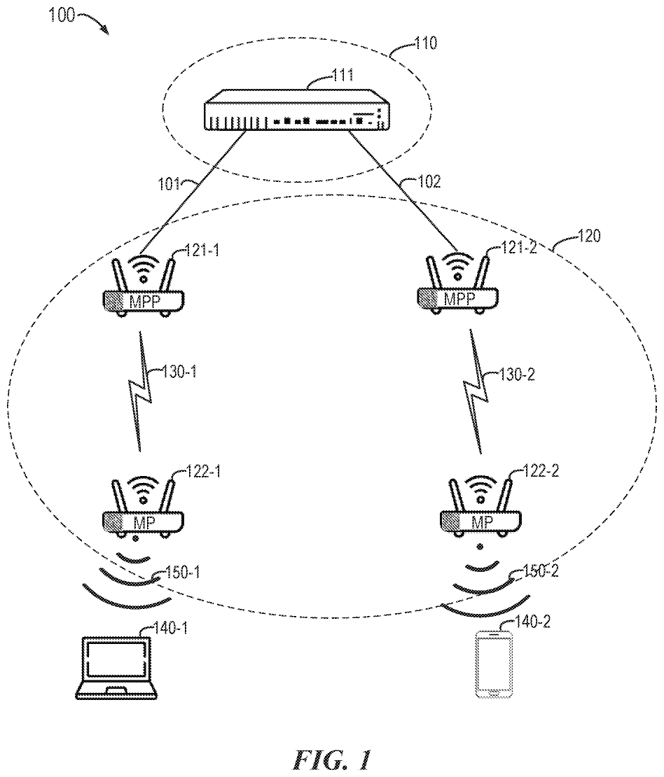

Other advantages of embodiments of the present disclosure will be described with reference to the example implementation as described below. Reference is made below to FIG. 1 through FIG. 8 to illustrate basic principles and several example embodiments of the present disclosure herein.

FIG. 1 illustrates an example environment 100 in which embodiments of the present disclosure can be implemented. As shown in FIG. 1, the environment 100 comprises a mesh network 120, a controller 111 for managing APs in the mesh network 120 and user devices 140-1 and 140-2 (collectively referred to as “user device 140”).

The mesh network 120 comprises a plurality of APs acting as their respective roles. As shown in FIG. 1, for example, the APs in the mesh network 120 include MPPs 121-1, 121-2 (collectively referred to as “AP 121” or “MPP 121”) and MPs 122-1, 122-2 (collectively referred to as “AP 122” or “MP 122”). For example, the MPP 121-1 is connected to the controller 111 via a wired or wireless connection 101 and the MPP 121-2 is connected to the controller 111 via a wired or wireless connection 102. Although the MPPs 121-1 and 121-2 are shown as connected to the same controller 111 in FIG. 1, it is to BE understood that this is merely for the purpose of simplification, without suggesting any limitation to the scope of the present disclosure. In some embodiments, for example, the MPPs 121-1 and 121-2 may connect to different controllers. It is also to be understood that the controller 211 as shown is merely a logic entity that manages APs in the mesh network 120. In some embodiments, the controller 111 may be implemented in a plurality of physical devices, which may have different locations. In FIG. 1, for example, the controller 111 may be a cloud server, which is located on cloud 110.

An MPP is the gateway between the wireless mesh network and the wired LAN or WAN such as the Internet. An MPP uses its wired or wireless interface (such as an Ethernet port, 4G-modem) to establish a link to the wired LAN or WAN. In some cases, multiple MPPs are deployed in one mesh work to support redundant mesh paths from the wireless mesh network to the wired LAN or WAN. An MP is configured to establish an all-wireless path to the MPP and to provide some WLAN services to the user devices or clients. The WLAN services comprise, but are not limited to, client connectivity, intrusion detection system (IDS) capabilities, user role association, LAN-to-LAN bridging, and Quality of Service (QoS) for LAN-to-mesh communication. In addition, the MP may also perform mesh backhaul and/or network connectivity.

In FIG. 1, for example, the MPPs 121-1 and 121-2 are wired to a WAN (not shown in FIG. 1), while the MPs 122-1 and 122-2 are connected wirelessly. The WAN may be a network that spans regions, countries, or even the world. The WAN is generally used to connect LANs and other types of networks together to enable communications among different devices. Examples of the WAN include, but are not limited to, the Internet. The MPPs 121-1 and 121-2 are gateways between the wireless mesh network 120 and the WAN, while the MPs 122-1 and 122-2 provide WLAN connectivity services for the user devices 140. In some embodiments, the mesh network 120 may be wired to another LAN.

The APs 121 and 122 are connected together via wireless mesh links to form the mesh network 120 based on their configurations. A configuration of an AP may comprise one or more parameters for establishing a mesh link with its neighbor, which include, but are not limited to, a network name, a network identifier (such as, Service Set Identifier, SSID), a network key. The configurations of these APs may indicate a same identifier such as a SSID specific to the mesh network (can be referred to as “mesh ID”). The MPPs 121-1 and 121-2 may broadcast the mesh ID, and the MPs 122-1 and 122-2 may then connect to the MPPs 121-1 and 121-2 based on the mesh ID.

A mesh link 130-1 is established between the MPP 121-1 and the MP 122-1 and a mesh link 130-2 is established between the MPP 121-2 and the MP 122-2. In this way, the MPs 122-1 and 122-2 can join the mesh network 120.

The MPs 122-1 and 122-2 may provide the wireless connectivity services in their respective coverage areas. For example, the MP 122-1 provides the wireless connectivity service via a wireless access link 150-1 to a user device 140-1 such as a laptop, and the MP 122-2 provides the wireless connectivity service via a wireless access link 150-2 to a user device 140-2 such as a mobile device. It is to be understood that the mesh network 120 may have more MPPs and/or may have more or less MPs. In addition, each MP may provide wireless connectivity service to two or more user devices.

In some embodiments, the MPP, MP and/or any other devices in the example environment 100 may each include, but are not limited to, a processor or processing unit, a memory, a storage device, a communication unit. The processor or processing unit may perform various processes based on the programs or instructions stored in the memory. The storage device may include machine-readable media, which may be used for storing information and/or data. The communication unit may include one or more antennas for conducting wireless communications with other devices.

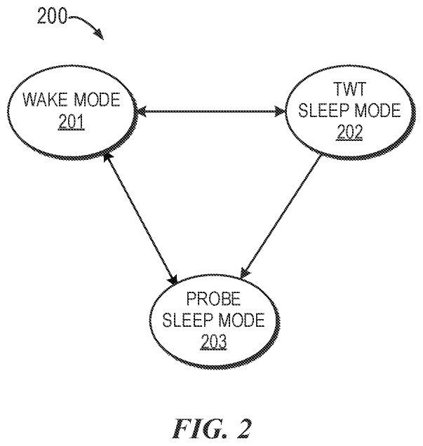

In order to implement power saving in a mesh network (for example, the mesh network 120 as shown in FIG. 1), embodiments of the present disclosure propose different sleep modes of an AP for different scenarios. FIG. 2 illustrates a schematic diagram of conversion among different modes of an AP according to embodiments of the present disclosure. For example, the AP can be any MP 122 shown in FIG. 1.

As shown in FIG. 2, initially, a MP that keeps awake is in a wake mode 201. The wake mode 201 refers to a normal working mode of an AP.

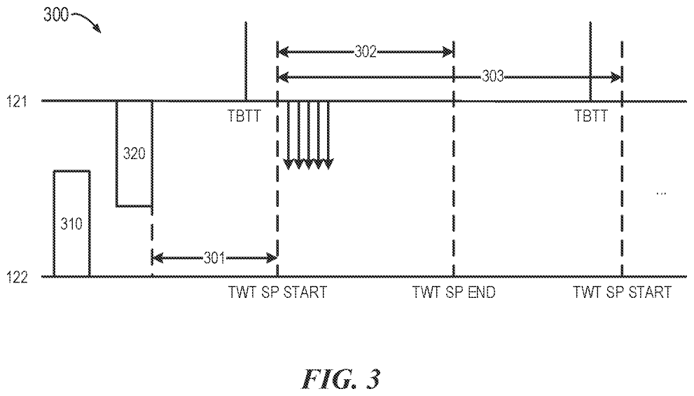

In some embodiments, if a controller (for example, the controller 111 shown in FIG. 1) sends a command to cause the MP to fall asleep and its associated MPP to keep awake, the MP may enter a sleep mode 202 called “target wake time (TWT) sleep mode”. The TWT sleep mode 202 allows the MPP (for example, acting as an AP) and the MP (for example, acting as a station) to negotiate and establish a TWT session to communicate with each other. After the TWT session is established, the MP can fall asleep and wake up periodically to communicate with the AP according to the negotiated parameters of the TWT session. For example, if the MP falls asleep, it will work in the lowest power consumption mode with the minimum requirements for the mesh link. The MP in the TWT sleep mode may wake up during the wake duration of the TWT session to detect a magic packet from the MPP. In some embodiments, the awake MPP may wake up the MP in the TWT sleep mode during the wake duration of the TWT session by transmitting a magic packet to the MP. In response to the magic packet being detected, the MP may return to the wake mode 201. The details of the TWT sleep mode 202 will be described in detail below with reference to FIG. 3.

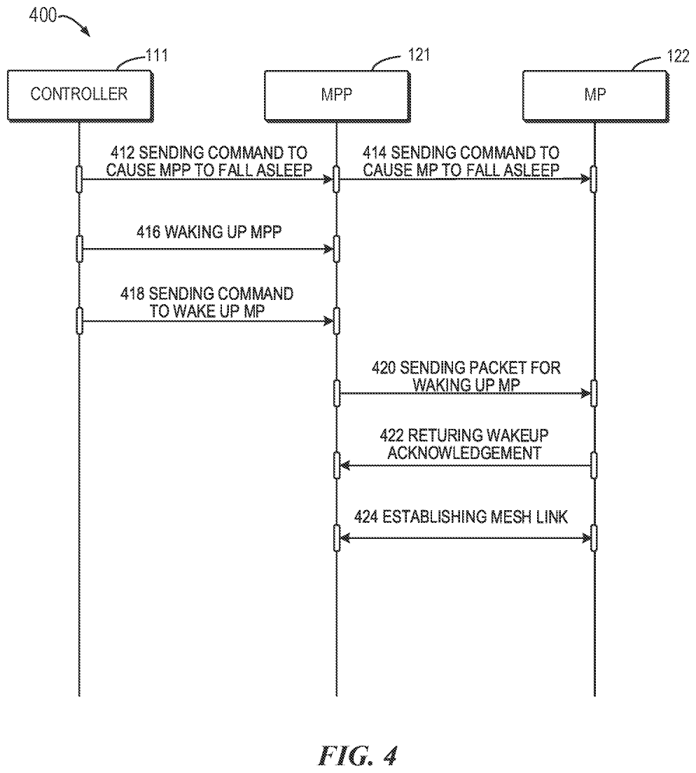

Alternatively, in some embodiments, if the controller sends a command to cause both the MP and its associated MPP to fall asleep, the MP may enter another sleep mode 203 called “probe sleep mode”. If the MPP falls asleep, it will work in the lowest power consumption mode with the minimum requirements for the mesh link. If the MP falls asleep, it will work in the lowest power consumption mode with the minimum requirements for the mesh link. The controller may decide to wake up the MPP and/or the MP. In some embodiment, if the controller decides to wake up the MPP, it may wake up the MPP based on WoLAN. In some embodiment, if the controller decides to wake up both the MPP and the MP, it may wake up the MPP at first and cause the MPP to wake up the MP. In some embodiments, the MPP may transmit a probe request to the MP during a predetermine time period or periodic time intervals for waking up the MP. The MP in the probe sleep mode 203 may wake up during the predetermine time period or periodic time intervals to detect the probe request from the MPP. In response to the probe request being detected, the MP may return to the wake mode 201. The details of the probe sleep mode 203 will be described in detail below with reference to FIG. 4.

In some embodiments, the TWT sleep mode 202 can be switched to the wake mode 201 as described above or switched to the probe sleep mode 203. For example, if the controller wants to schedule the awake MPP to fall asleep later, it may send an additional command to the MPP and then the MPP may cause the sleeping MP to switch from the TWT sleep mode 202 to the probe sleep mode 203. Before the switching from the TWT sleep mode 202 to the wake mode 201 or the probe sleep mode 203, both the MPP and the MP can deal with the negotiated TWT session. For example, the MPP or the MP can pause the TWT session via transmitting a TWT info action frame. In this case, the MPP and the MP may resume or renegotiate the TWT session w % ben the MP returns back to the TWT sleep mode 202. For another example, the MPP or the MP can tear down the TWT session via transmitting a TWT teardown frame. In this case, the MPP and the MP may need to renegotiate the TWT session when the MP returns back to the TWT sleep mode 202. In some embodiments, when the MP is in the TWT sleep mode 202, it may still remain the mesh link with the MPP. In some embodiments, when the MP is in the probe sleep mode 203, it may lose the mesh link with the MPP. That is, when the MP switches from the probe sleep mode 203 to the wake mode 201, it may reestablish the mesh link with the MPP. In some embodiments, the probe sleep mode 203 cannot be switched back to the TWT sleep mode 202.

FIG. 3 illustrates a schematic diagram of the TWT sleep mode according to embodiments of the present disclosure. In some embodiments, if a controller (for example, the controller 111 shown in FIG. 1) sends a command to cause the MP 122 to fall asleep and its associated MPP 121 to keep awake, the MP 122 may enter the TWT sleep mode 202. For example, the MP 122 and the MPP 121 may negotiate and establish a TWT session 300 to communicate with each other.

As shown in FIG. 3, the MP 122 acting as a station may send a TWT request 310 to the MPP 121 acting as an AP to negotiate timing information for the TWT session 300. In response to determining the timing information for the TWT session 300, the MPP 121 may send, to the MP 122, a TWT response 320 comprising the timing information. The timing information may comprise TWT parameters for the TWT session 300, including a TWT start offset 301, wake duration 302 and a wake interval 303. The TWT session 300 may include a plurality of service periods (SPs). The TWT start offset 301 may indicate a start time of an initial SP. The wake duration 302 may indicate a time period during which the MP 122 will wake up to communicate with the MPP 121. The wake interval 303 may indicate a time interval between two successive SPs.

In some embodiments, the MPP 121 may transmit, during the wake duration 302, a magic packet for waking up the MP 122. For example, the magic packet may be transmitted in response to receiving a command from the controller for waking up the MP 122. The MP 122 in the TWT sleep mode 202 may wake up during the wake duration 302 to detect the magic packet from the MPP 121. In response to the magic packet being detected, the MP 122 may switch from the TWT sleep mode 202 to the wake mode 201. The MP 122 may then establish a mesh link with the MPP 121 in the wake mode 201 based on a mesh configuration. If the magic packet is not detected during the wake duration 302, the MP 122 will remain in the TWT sleep mode 202.

In some embodiments, for example, the MP 122 may only receive packets from the MPP 121 without transmitting any packet to the MPP 121. This is because transmitting packets would consume more power than receiving packets. By avoid transmitting packets to the MPP 121, the power consumption of the MP 122 can be reduced.

In some embodiments, for example, the TWT session 300 may be an unannounced and non-triggered TWT session. An unannounced TWT session means that the MPP 121 can send data packets to the MP 122 without any trigger from the MP 122 as soon as a SP starts. A non-triggered TWT session means that the MPP 121 does not need to wait for a trigger from the MP 122 before it can send data packets to the MP 122. In this way, the power consumption of the MP 122 can be reduced as much as possible.

In some embodiments, the magic packet may be a unicast User Datagram Protocol (UDP) frame, so as to avoid an explicit acknowledgement from the MP 122. For example, the MPP 121 may generate the magic packet by encoding magic information using length information of serial UDP packets. The magic information may be shared between the MPP 121 and the MP 122. Accordingly, the MP 122 may decode the received packet using length information of serial UDP packets. If the result of the decoding matches the magic information, it means that the magic packet is detected by the MP 122. Alternatively, in some embodiments, the magic packet may be a Physical Layer Convergence Procedure (PLCP) Protocol Data Unit (PPDU) with only PHY data but no payload (also referred to as “0-length PPDU”), such as, a sounding PPDU. Alternatively, in some embodiments, the magic packet may be a vendor specific magic packet.

FIG. 4 illustrates a signaling chart of an example process 400 for entering and waking up from the probe sleep mode according to embodiments of the present disclosure. In the process 400, for example, the controller 111, the MPP 121 and the MP 122 shown in FIG. 1 are involved.

As shown in FIG. 4, the controller 111 may send (412, 414) one or more commands to the MPP 121 and the MP 122 to cause them to fall asleep. In some embodiments, the commands may also include a configuration about a predetermined time period, during which the MP 122 will wake up to detect a probe request from the MPP 121. Alternatively, the predetermined time period may include periodic time intervals, during which the MP 122 will wake up periodically to detect the probe request from the MPP 121. Alternatively, in some embodiments, the controller 111 may send separate configurations to the MPP 121 and the MP 122 for configuring the predetermined time period or periodic time intervals. Alternatively, in some embodiments, the MPP 121 and the MP 122 may negotiate with each other the predetermined time period or periodic time intervals. Then, both the MPP 121 and the MP 122 may fall asleep and the MP 122 may enter the probe sleep mode.

In response to a determination to wake up the MPP 121, the controller 111 may wake (416) up the MPP 121 based on the WoLAN. In response to a determination to wake up the MP 122, the controller 111 may send (418) a command to the MPP 121 for waking up the MP 122. In some embodiments, the controller III may determine to wake up both the MPP 121 and the MP 122 at the same time. Alternatively, in other embodiments, the controller 111 may wake up the MPP 121 first and then cause the MPP 121 to wake up the MP 122.

As shown in FIG. 4, in response to the command from the controller 111, the MPP 121 may send (420) a packet (also referred to “probe request”) to the MP 122 during the predetermined time period. In some embodiments, the probe request may include a predefined information element (IE) for the purpose of waking up the MP. The MP 122 may wake up during the predetermined time period to detect the probe request from the MPP 121. In response to the probe request being detected during the predetermined time period, the MP 122 may switch from the probe sleep mode to the wake mode. In response to the probe request being not detected during the predetermined time period, the MP 122 may remain in the probe sleep mode. In some embodiments, if there is no available MPP 121 in the mesh network work, the MP 122 may go back to the probe sleep mode after timeout. It is to be understood that, the MP 122 may only receive a probe request from a legal MPP 121. As such, even if the MPP 121 transmits a fake probe request, there will be no security concern.

As shown in FIG. 4, in response to the probe request being detected, the MP 122 may return (422) a wakeup acknowledgement to the MPP 121. In response to receiving the wakeup acknowledgement from the MP 122, the MPP 121 may determine that the MP 122 is waked up. Then, the MP 122 may establish (422) a mesh link with the MPP 121 based on a mesh configuration.

In view of the above, it can be seen that embodiments of the present disclosure propose a solution for power saving. This solution enables one or more APs (for example, a MPP and/or a MP) in a mesh network to fall asleep and wake up. According to this solution, if only a MP falls asleep and a MPP keeps awake, the MP can be waked up by a MPP. If both a MPP and a MP fall asleep, the MPP can be waked up based on WoLAN and then the MP can be waked up by the MPP. In this way, power saving in a mesh network can be implemented.

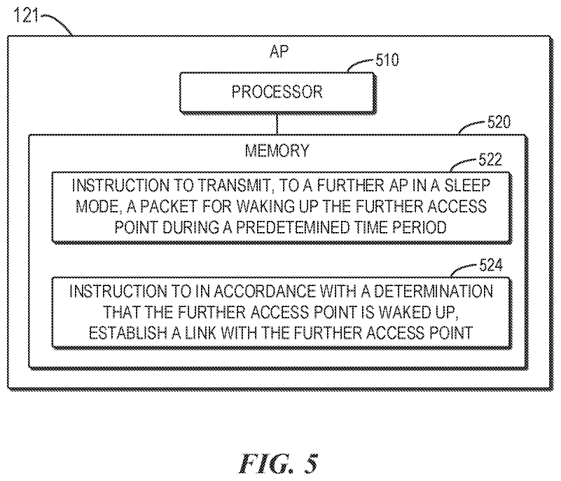

FIG. 5 illustrates an example AP 121 according to embodiments of the present disclosure. The AP 121 comprises a processor 510 and a memory 520 coupled to the processor 510. The memory 520 stores instructions 522 and 524 to cause the processor 510 to perform some acts.

As shown in FIG. 5, the memory 520 stores instruction(s) 522 to transmit, to a further AP 122 in a sleep mode, a packet for waking up the further AP 122 during a predetermined time period. For example, the sleep mode may be a TWT sleep mode or a probe sleep mode as described above. The further AP 122 in the sleep mode may detect the packet during the predetermined time period.

In some embodiments, prior to the further AP 122 entering the sleep mode, the AP 121 may negotiate the predetermined time period with the further AP 122.

In some embodiments, in order to negotiate the predetermined time period with the further AP 122, the AP 121 may receive, from the further AP 122, a request to negotiate timing information for a TWT session between the AP 121 and the further AP 122. The AP 121 may determine the timing information for the TWT session, where the timing information indicates the predetermined time period. Then, the AP 121 may transmit, to the further AP 122, a response comprising the timing information. In some embodiments, the TWT session is an unannounced and non-triggered TWT session. In some embodiments, the packet comprises one of the following: a unicast UDP frame; a PPDU with no payload, or a vendor specific magic packet.

In some embodiments, the AP 121 may receive, from a controller managing the AP 121 and the further AP 122, a configuration about the predetermined time period.

In some embodiments, the AP 121 may receive, from a controller managing the AP 121 and the further AP 122, a command for waking up the further AP 122. In response to the command, the AP 121 may transmit the packet to the further AP 122 during the predetermined time period.

As shown in FIG. 5, the memory 520 stores instruction(s) 524 to establish a link with the further access point in accordance with a determination that the further AP 122 is waked up.

In some embodiments, in response to receiving an acknowledgement from the further AP 122 that the packet is detected, the AP 121 may determine that the further AP 122 is waked up.

In some embodiments, the AP 121 may be a MPP in a mesh network and the further AP 122 may be a MP in the mesh network. The AP 121 may establish a mesh link with the MP based on a mesh configuration.

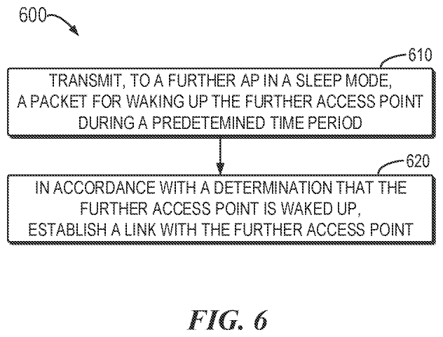

FIG. 6 illustrates a flow chart of an example method 600 for power saving according to embodiments of the present disclosure. It is to be understood that the method 600 may be executed by any MPP 121 as described with reference to FIGS. 1-5.

At 610, a MPP transmits, to a MP in a sleep mode, a packet for waking up the MP during a predetermined time period. At 620, in accordance with a determination that the MP is waked up, the MPP establishes a mesh link with the MP.

In some embodiments, prior to the MP entering the sleep mode, the MPP may negotiate the predetermined time period with the MP.

In some embodiments, in order to negotiate the predetermined time period with the MP, the MPP may receive, from the MP, a request to negotiate timing information for a TWT session between the MPP and the MP. The MPP may determine the timing information for the TWT session, where the timing information indicates the predetermined time period. Then, the MPP may transmit, to the MP, a response comprising the timing information. In some embodiments, the TWT session may be an unannounced and non-triggered TWT session. In some embodiments, the packet may comprise one of the following: a unicast UDP frame; a PPDU with no payload; or a vendor specific magic packet.

In some embodiments, the MPP may receive, from a controller managing the MPP and the MP, a configuration about the predetermined time period.

In some embodiments, the MPP may receive, from a controller managing the MPP and the MP, a command for waking up the MP. In response to the command, the MPP may transmit the packet to the MP during the predetermined time period.

In some embodiments, in response to receiving an acknowledgement from the MP that the packet is detected, the MPP may determine that the MP is waked up.

In some embodiments, the MPP may establish a mesh link with the MP based on a mesh configuration.

In this way, if only a MP falls asleep and a MPP keeps awake, the MP can be waked up by a MPP. If both a MPP and a MP fall asleep, the MPP can be waked up based on WoLAN and then the MP can be waked up by the MPP. Therefore, power consumption of APs in a mesh network can be reduced.

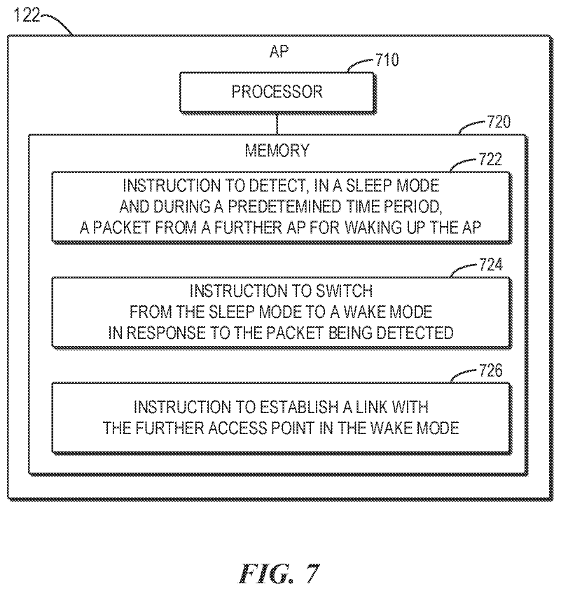

FIG. 7 illustrates an example AP 122 according to embodiments of the present disclosure. The AP 122 comprises a processor 710 and a memory 720 coupled to the processor 710. The memory 720 stores instructions 722, 724 and 726 to cause the processor 710 to perform some acts.

As shown in FIG. 7, the memory 720 stores instruction(s) 722 to detect, in a sleep mode and during a predetermined time period, a packet from a further AP 121 for waking up the AP 122. For example, the sleep mode may be a TWT sleep mode or a probe sleep mode as described above.

In some embodiments, prior to entering the sleep mode, the AP 122 may negotiate the predetermined time period with the further AP 121.

In some embodiments, in order to negotiate the predetermined time period with the further AP 121, the AP 122 may transmit, to the further AP 121, a request to negotiate timing information for a TWT session between the further AP 121 and the AP 122. The AP 122 may receive, from the further AP 121, a response comprising the timing information, the timing information indicating the predetermined time period. In some embodiments, the TWT session may be an unannounced and non-triggered TWT session. In some embodiments, the packet may comprise one of the following: a unicast UDP frame; a PPDU with no payload; or a vendor specific magic packet.

In some embodiments, the AP 122 may receive, from a controller managing the AP 122 and the further AP 121, a configuration about the predetermined time period.

As shown in FIG. 7, the memory 720 stores instruction(s) 724 to switch from the sleep mode to a wake mode in response to the packet being detected.

In some embodiments, in response to the packet being detected, the AP 122 may transmit an acknowledgement that the packet is detected to the further AP 121. As such, the further AP 121 can determine that the AP 122 is waked up.

As shown in FIG. 7, the memory 720 stores instruction(s) 726 to establish a link with the further AP 121 in the wake mode.

In some embodiments, the AP 122 may be a MP in a mesh network and the further AP 121 may be a MPP in the mesh network. The AP 122 in the wake mode may establish a mesh link with the MPP based on a mesh configuration.

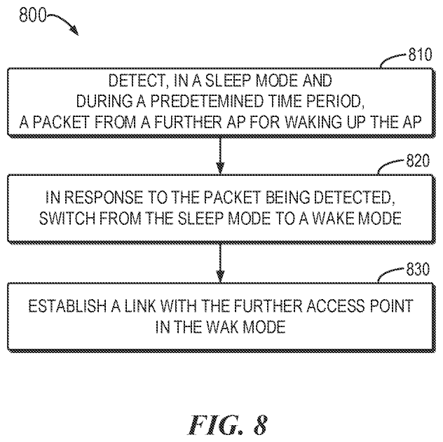

FIG. 8 illustrates a flow chart of an example method 800 for power saving according to embodiments of the present disclosure. It is to be understood that the method 800 may be executed by any MP 122 as described with reference to FIGS. 1-7.

At 810, a MP in a sleep mode detects, during a predetermined time period, a packet from a MPP for waking up the MP. At 820, in response to the packet being detected, the MP switches from the sleep mode to a wake mode. At 830, the MP establishes a link with the MPP in the wake mode.

In some embodiments, prior to entering the sleep mode, the MP may negotiate the predetermined time period with the MPP.

In some embodiments, in order to negotiate the predetermined time period with the MPP, the MP may transmit, to the MPP, a request to negotiate timing information for a TWT session between the MPP and the MP. The MP may receive, from the MPP, a response comprising the timing information, the timing information indicating the predetermined time period. In some embodiments, the TWT session may be an unannounced and non-triggered TWT session. In some embodiments, the packet may comprise one of the following: a unicast UDP frame; a PPDU with no payload; or a vendor specific magic packet.

In some embodiments, the MP may receive, from a controller managing the MPP and the MP, a configuration about the predetermined time period.

In some embodiments, in response to the packet being detected, the MP may transmit an acknowledgement that the packet is detected to the MPP.

In some embodiments, the MP in the wake mode may establish a mesh link with the MPP based on a mesh configuration.

In this way, if only a MP falls asleep and a MPP keeps awake, the MP can be waked up by a MPP. If both a MPP and a MP fall asleep, the MPP can be waked up based on WoLAN and then the MP can be waked up by the MPP. Therefore, power consumption of APs in a mesh network can be reduced.

Program codes or instructions for carrying out methods of the present disclosure may be written in any combination of one or more programming languages. These program codes or instructions may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine or entirely on the remote machine or server.

In the context of this disclosure, a machine-readable medium may be any tangible medium that may contain, or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Certain features that are described in the context of separate embodiments may also be implemented in combination in a single implementation. Conversely, various features that are described in the context of a single implementation may also be implemented in multiple embodiments separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. An access point comprising:
a processor; and
a memory coupled to the processor, the memory storing instructions to cause the processor to perform acts comprising:
transmitting, to a further access point in a sleep mode, a packet for waking up the further access point during a predetermined time period, the further access point in the sleep mode detecting the packet during the predetermined time period; and
in accordance with a determination that the further access point is waked up, establishing a link with the further access point.

2. The access point of claim 1, further comprising:
prior to the further access point entering the sleep mode, negotiating the predetermined time period with the further access point.

3. The access point of claim 2, wherein negotiating the predetermined time period with the further access point comprises:
receiving, from the further access point, a request to negotiate timing information for a target wakeup time (TWT) session between the access point and the further access point;
determining the timing information for the TWT session, the timing information indicating the predetermined time period; and
transmitting, to the further access point, a response comprising the timing information.

4. The access point of claim 3, wherein the packet comprises one of the following:
a unicast User Datagram Protocol (UDP) frame:
a Physical Layer Convergence Procedure (PLCP) Protocol Data Unit (PPDU) with no payload; or
a vendor specific magic packet.

5. The access point of claim 3, wherein the TWT session is an unannounced and non-triggered TWT session.

6. The access point of claim 1, wherein the acts further comprise:
receiving, from a controller managing the access point and the further access point, a configuration about the predetermined time period.

7. The access point of claim 1, wherein transmitting the packet comprises:
receiving, from a controller managing the access point and the further access point, a command for waking up the further access point; and
in response to the command, transmitting the packet to the further access point during the predetermined time period.

8. The access point of claim 1, wherein the acts further comprise:
in response to receiving an acknowledgement from the further access point that the packet is detected, determining that the further access point is waked up.

9. The access point of claim 1, wherein the access point is a mesh portal in a mesh network, the further access point is a mesh point in the mesh network, and establishing a link with the further access point comprises:
establishing a mesh link between the mesh portal and the mesh point.

10. An access point comprising:
a processor; and
a memory coupled to the processor, the memory storing instructions to cause the processor to perform acts comprising:
detecting, in a sleep mode and during a predetermined time period, a packet from a further access point for waking up the access point;
in response to the packet being detected, switching from the sleep mode to a wake mode; and
establishing a link with the further access point in the wake mode.

11. The access point of claim 10, wherein the acts further comprise:
prior to entering the sleep mode, negotiating the predetermined time period with the further access point.

12. The access point of claim 11, wherein negotiating the predetermined time period with the further access point comprises:
transmitting, to the further access point, a request to negotiate timing information for a target wakeup time (TWT) session between the further access point and the access point; and
receiving, from the further access point, a response comprising the timing information, the timing information indicating the predetermined time period.

13. The access point of claim 11, wherein the packet comprises one of the following:
a unicast User Datagram Protocol (UDP) frame;
a Physical Layer Convergence Procedure (PLCP) Protocol Data Unit (PPDU) with no payload; or
a vendor specific magic packet.

14. The access point of claim 11, wherein the TWT session is an unannounced and non-triggered TWT session.

15. The access point of claim 11, wherein the acts further comprise:
receiving, from a controller managing the further access point and the access point, a configuration about the predetermined time period.

16. The access point of claim 11, wherein the acts further comprise:
in response to the packet being detected, transmitting an acknowledgement that the packet is detected to the further access point.

17. The access point of claim 11, wherein the access point is a mesh point in a mesh network, the further access point is a mesh portal in the mesh network, and establishing a link with the further access point comprises:
establishing a mesh link between the mesh portal and the mesh point.

18. A method comprising:
transmitting, from a mesh portal to a mesh point in a sleep mode, a packet for waking up the mesh point during a predetermined time period, the mesh point in the sleep mode detecting the packet during the predetermined time period; and
in accordance with a determination that the mesh point is waked up, establishing a mesh link with the mesh point.

19. The method of claim 18, further comprising:
prior to the mesh point entering the sleep mode, negotiating the predetermined time period with the mesh point.

20. The method of claim 18, further comprising:
receiving, from a controller managing the mesh portal and the mesh point, a configuration about the predetermined time period.
